(19) United States
(12) Patent Application Publication
(10) Pub. No.: US 2010/0169151 A1
(43) Pub. Date: Jul. 1, 2010

(54) ALARMING SYSTEM AND METHOD FOR PROTECTING MALICIOUS ACCESS TO BANK ACCOUNTS

(75) Inventor: XIN XU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); Chi Mei Communication Systems, Inc., Tu-Cheng City (TW)

(21) Appl. No.: 12/579,501

(22) Filed: Oct. 15, 2009

(30) Foreign Application Priority Data
Dec. 27, 2008 (CN) 200810306592.4

(51) Int. Cl. G06Q 40/00; G06F 15/16; G06Q 10/00

(52) U.S. Cl. 705/9; 709/204; 705/35; 705/30

(57) ABSTRACT

An alarm system and method include setting an alarm password corresponding to the bank account and setting a restricted amount of the bank account, acquiring account information of the bank account if the alarm password is received, and sending the alarm message including the account information to a receiving device of one or more emergency dispatchers. The alarm system and method further include displaying the restricted amount on an account interface provided by a bank server if the account balance is greater than the restricted amount, or displaying the account balance on the account interface if the account balance is less than the restricted amount.

### BACKGROUND

1. Technical Field

Embodiments of the present disclosure relate to data securing, and more particularly to an alarm system and method for securing bank accounts.

2. Description of Related Art

Most banks provide various means for people to manage their bank accounts. For example, people may withdraw money from an automatic teller machine (ATM) provided by the bank, or transfer money through the Internet by using computers, such as Internet banking. However, the banks are unable to know if a certain bank account is accessed normally or under force and/or threat, as a result, funds in the certain bank account may be removed illegally.

What is needed, therefore, is an improved alarm system and method for securing bank accounts.

### BRIEF DESCRIPTION OF THE DRAWINGS

FIG. 1 is a block diagram of one embodiment of a bank server in communication with a plurality of terminal computing devices.

FIG. 2 is a block diagram of one embodiment of the bank server including an alarm system.

FIG. 3 is a schematic diagram of one embodiment of an alarm message.

FIG. 4 is a schematic diagram of one embodiment of a dialog message.

FIG. 5-1 and FIG. 5-2 are flowcharts of one embodiment of a bank alarm method for securing bank accounts using the bank server of FIG. 2.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

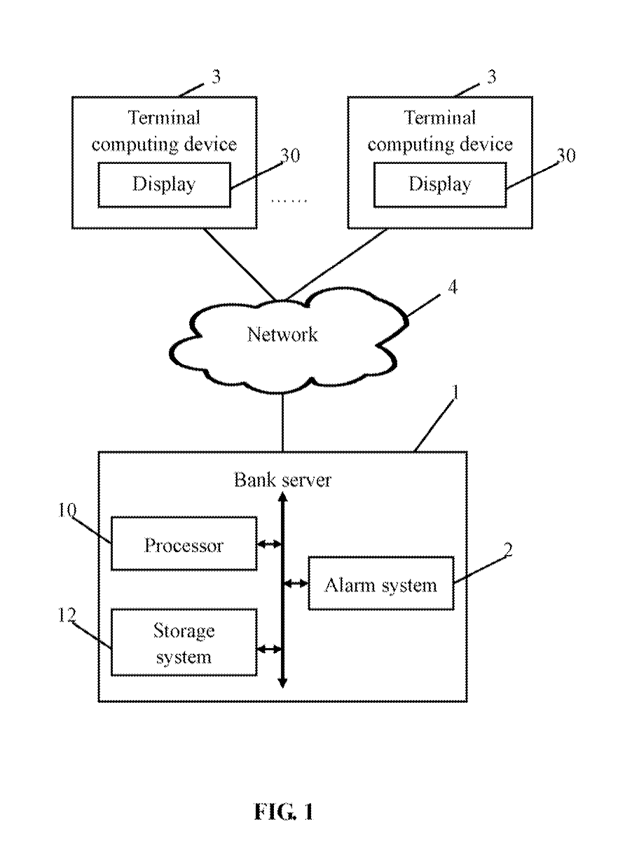

FIG. 1 is a block diagram of one embodiment of a bank server 1 in communication with a plurality of terminal computing devices 3. The bank server 1 includes an alarm system 2. The alarm system 2 may be used to send alarm messages to a receiving device of one or more emergency dispatchers (e.g., the police) when a bank account is in an abnormal state (e.g., out of control by the owner of the bank account). In one embodiment, an alarm password corresponding to the bank account may be preset. The alarm system 2 may identify that the bank account is in the abnormal state if the bank server 1 receives the alarm password. By utilizing the alarm system 2, funds in the bank account may be protected from malicious use.

In one embodiment, the bank server 1 may be a host computer of a bank, for example. The bank server 1 may run various kinds of programs to manage bank accounts of different users. In one embodiment, the bank server 1 provides various interfaces for people to login, browse account information, manage the bank accounts, do on-line transactions, and/or transfer money, for example.

The bank server 1 may further include a processor 10 and a storage system 12. The processor 10 executes one or more computerized operations of the bank server 1 and other applications, to provide functions of the bank server 1. The storage system 12 stores one or more programs, such as programs of an operating system, other applications of the bank server 1, and various kinds of data, such as the account information of the bank accounts, for example. In one embodiment, the storage system 12 may be a memory of the bank server 1 (e.g., a hard disk) or an external storage device, such as a memory stick, a mobile hard disk, or any other type of memory card.

In one embodiment as shown in FIG. 1, the bank server 1 may communicate with the terminal computing devices 3 through a network 4. The network 4 may be the Internet, communication networks (e.g., Global System for Mobile communication), for example.

The terminal computing devices 3 may be automatic teller machines (ATMs), mobile phones, personal digital assistants (PDAs), handheld computers, or any other kind of computing devices. For example, the terminal computing device may be an ATM, which may provide various functions performed on the bank accounts, such as withdrawing money, transferring money, changing a password, for example.

The receiving device of the emergency dispatchers (e.g, the police) may be a web server providing an alarm platform of the police.

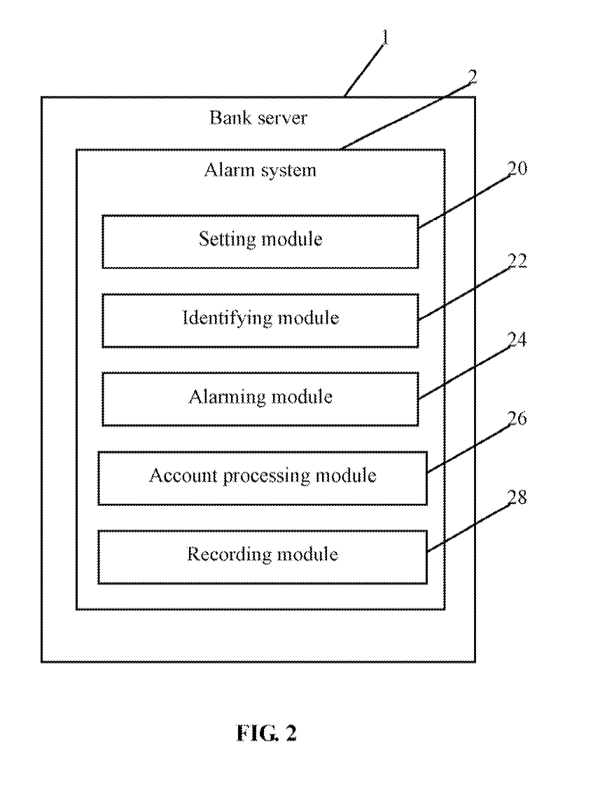

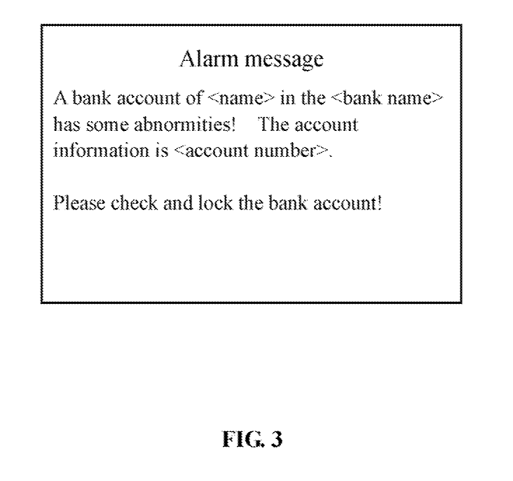

FIG. 2 is a block diagram of one embodiment of the bank server 1 including the alarm system 2. In one embodiment, the alarm system 2 includes a setting module 20, an identifying module 22, an alarming module 24, an account processing module 26, and a recording module 28. The modules 20, 22, 24, 26, and 28 may comprise one or more computerized codes to be executed by the processor 10 to perform one or more operations of the bank server 1. Details of these operations will be provided below.

The setting module 20 is operable to set an alarm password corresponding to a bank account of a bank. In one embodiment, when a user applies for a new bank account in a bank, an access password and an alarm password corresponding to the new bank account are required to be set. Either of the access password and the alarm password may be used to login to the bank account The access password is used to access the bank account normally and to perform regular banking transactions. The alarm password is used to activate/invoke an alarm function when an abnormal banking transaction occurs. For example, if a bank card (e.g., a credit card, a debit card) of the user is in a criminal's hand, and the criminal forces the user to tell a password of the bank card so as to withdraw money, the user may tell the alarm password to the criminal so as to invoke the alarm function to secure the money.

The setting module 20 is also operable to preset a format and content of an alarm message. As an example of the alarm message shown in FIG. 3, the alarm message may include account information of the bank account, such as a name, an account number (e.g., a bank card number), bank information (e.g., a bank name), and personal information (e.g., a phone number, a home address). In one embodiment, the alarm message may be sent to the receiving device of one or more emergency dispatchers (e.g., the police, the bank) so as to secure the money of the bank account. When the emergency dispatchers receive the alarm message, they may lock the bank account, contact the user of the bank account, and/or send the police to perform a rescue.

The setting module 20 is further operable to set a restricted amount of money in the bank account, and set a transaction condition that a transaction amount should be less than the restricted amount. In one embodiment, the restricted amount may be displayed instead of an actual account balance of the bank account if the actual account balance is greater than the restricted amount.

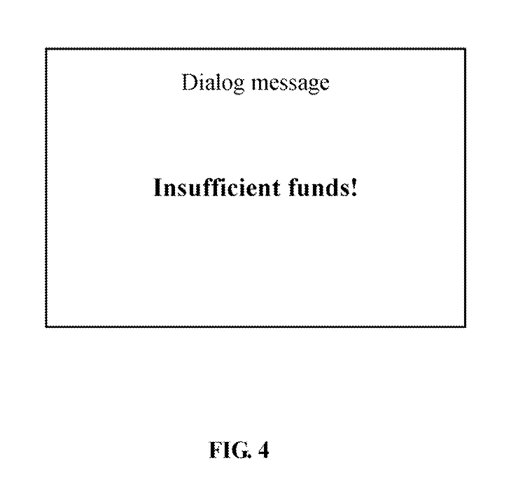

The setting module 20 is further operable to set restricted actions on the bank account, and set dialog messages to display that a restricted action is denied in response to receive an instruction of the restricted action. In one embodiment, the restricted actions may be transferring money, withdrawing money, for example. In another embodiment, as shown in FIG. 4, the dialog message may display “insufficient funds,” for example.

The identifying module 22 receives information of the bank account and an input password in response to receiving user input, and determines if the input password is the alarm password.

If the input password is the alarm password, the alarming module 24 acquires the account information of the bank account, and generates an alarm message that is populated with the account information according to the preset format of the alarm message. Then the alarming module 24 sends the alarm message to the receiving device of one or more emergency dispatchers. In one embodiment, the alarm message may be sent through the communication network, or the Internet.

The account processing module 26 logs into the bank account, compares the account balance of the bank account with the restricted amount, and determines if the account balance is greater than the restricted amount.

If the account balance is greater than the restricted amount, the account processing module 26 displays the restricted amount on an account interface provided by the bank server 1. If the account balance is less than the restricted amount, the account processing module 26 displays the account balance on the account interface. For example, an account balance of a bank account is 1000 dollars, and a restricted amount is set as 100 dollars. When the bank server 1 receives an alarm password of the bank account, the account processing module 26 displays an account interface presenting that the account balance is 100 dollars.

The account processing module 26 may be further operable to manage the bank account in response to receiving user actions. Management of the bank account may include querying account amount of the bank account, transferring money of the bank account, and on-line trading, for example.

In one embodiment, the account processing module 26 receives an instruction of a current action on the bank account, and determines if the current action is one of the restricted actions. If the current action is one of the restricted actions, the account processing module 26 displays the dialog message on the account interface to display that the current action is denied. Otherwise, if the current action is not one of the restricted actions, the account processing module 26 allows the current action.

The alarming module 24 and the account processing module 26 perform corresponding functions at the same time when the alarm password is received.

The recording module 28 records all actions applied to the bank account, and generates an action log including the recorded actions. In one embodiment, the actions may include viewing the account information, transferring the money of the bank account, for example. The recording module 28 further stores the action log into the storage system 12.

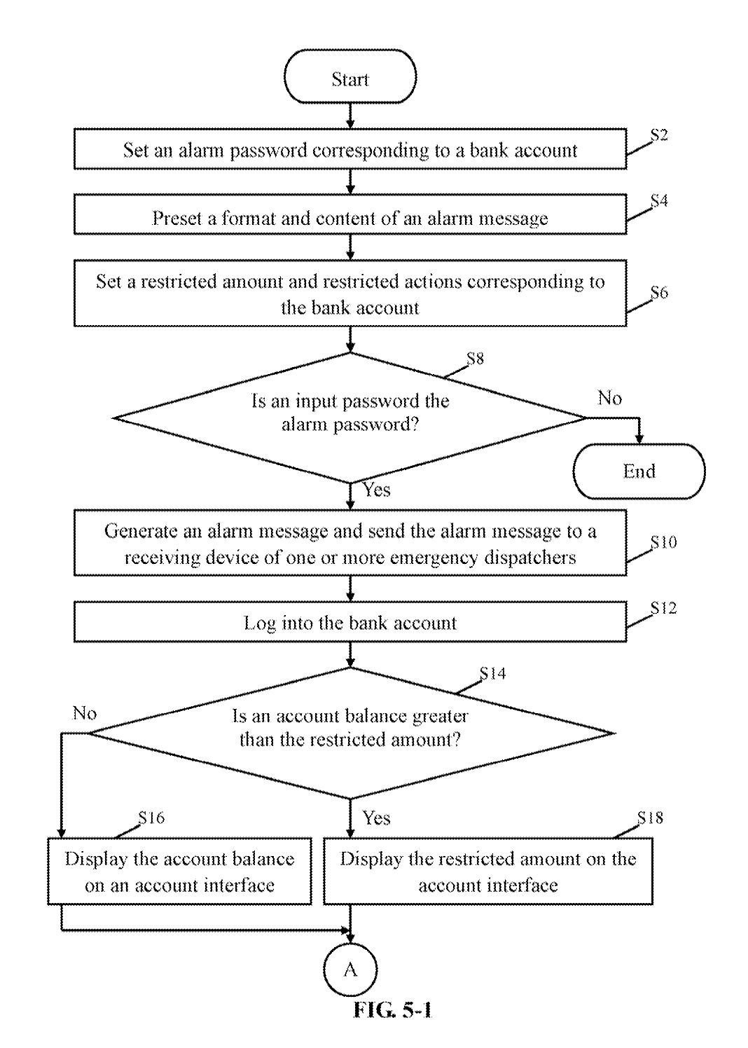

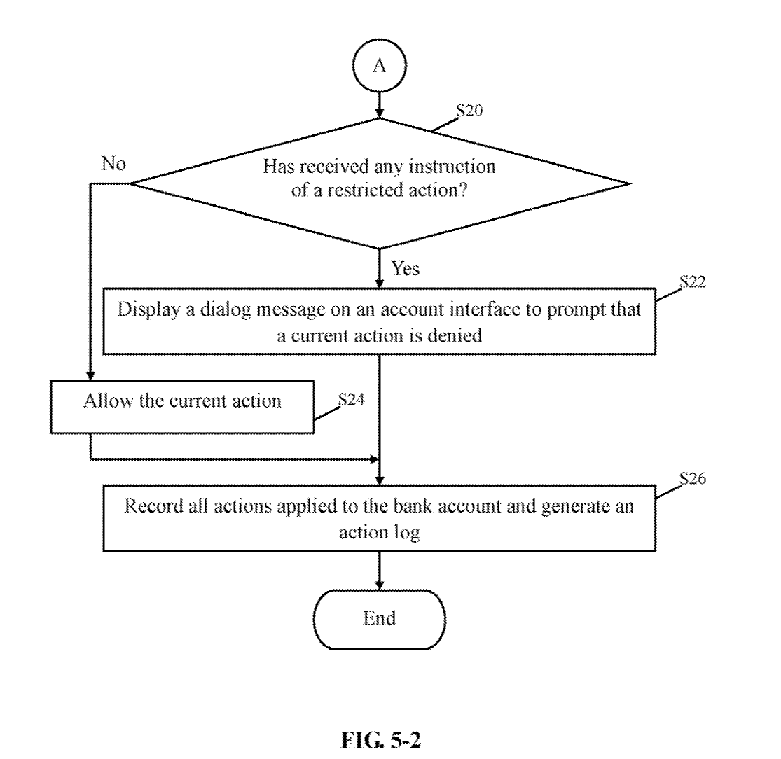

FIG. 5-1 and FIG. 5-2 are flowcharts of one embodiment of a bank alarm method for securing bank accounts using the bank server 1 of FIG. 2. Depending on the embodiment, additional blocks may be added, others removed, and the ordering of the blocks may be replaced.

In block S2, the setting module 20 sets an alarm password corresponding to a bank account of a bank. As mentioned above, the alarm password is used to activate/invoke an alarm function when an abnormal banking transaction occurs.

In block S4, the setting module 20 presets a format of an alarm message. As an example of the alarm message shown in FIG. 3, the alarm message may include account information of the bank account, such as a name, an account number (e.g., a bank card number), bank information (e.g., a bank name), and personal information (e.g., a phone number, a home address).

In block S6, the setting module 20 sets a restricted amount of money in the bank account, sets restricted actions on the bank account, and sets a dialog message to display that a restricted action is denied in response to receive an instruction of the restricted action is received. As mentioned above, the restricted actions may be transferring money, withdrawing money, for example. In one embodiment, as shown in FIG. 4, the dialog message may display that “insufficient funds,” for example.

In block S8, the identifying module 22 receives information of the bank account and an input password in response to receiving user input, and determines if the input password is the alarm password. If the input password is not the alarm password, the procedure ends.

If the input password is the alarm password, in block S10, the alarming module 24 acquires the account information of the bank account, generates an alarm message that is populated with the account information according to the preset format of the alarm message, and sends the alarm message to the receiving device of one or more emergency dispatchers (e.g., the police).

In block S12, the account processing module 26 logs into the bank account.

In block S14, the account processing module 26 compares the account balance of the bank account with the restricted amount, and determines if the account balance is greater than the restricted amount.

If the account balance is less than the restricted amount, in block S16, the account processing module 26 displays the account balance on the account interface if the account balance is less than the restricted amount. If the account balance is greater than the restricted amount, in block 518, the account processing module 26 displays the restricted amount on an account interface provided by the bank server 1.

In block S20, the account processing module 26 receives an instruction of a current action on the bank account, and determines if the current action is one of the restricted actions. If the current action is one of the restricted actions, in block S22, the account processing module 26 displays the dialog message on the account interface to prompt that the current action is denied. Otherwise, if the current action is not one of the restricted actions, in block S24, the account processing module 26 allows the current action.

In block S26, the recording module 28 records all actions applied to the bank account, generates an action log including the recorded actions, and stores the action log into the storage system 12.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A bank alarm method for securing bank accounts, the method comprising:
setting an alarm password corresponding to a bank account of a bank, and setting a restricted amount of money in the bank account;
receiving information of the bank account and an input password in response to receiving user input;
determining if the input password is the alarm password;
acquiring account information of the bank account if the input password is the alarm password;
generating an alarm message that is populated with the account information, and sending the alarm message to a receiving device of one or more emergency dispatchers;
logging into the bank account;
comparing an account balance of the bank account with the restricted amount, and determining if the account balance is greater than the restricted amount;
displaying the restricted amount on an account interface provided by a bank server of the bank if the account balance is greater than the restricted amount; or
displaying the account balance on the account interface if the account balance is less than the restricted amount.

2. The method according to claim 1, further comprising:
setting restricted actions on the bank account; and
setting a dialog message to display that a restricted action is denied in response to receive an instruction of the restricted action.

3. The method according to claim 2, further comprising:
receiving an instruction of a current action on the bank account, and determining if the current action is one of the restricted actions;
displaying the dialog message on the account interface to prompt that the current action is denied if the current action is one of the restricted actions; or allowing the current action if the current action is not one of the restricted actions.

4. The method according to claim 1, further comprising:
recording all actions applied to the bank account;
generating an action log comprising the recorded actions; and
storing the action log into a storage system of the bank server.

5. The method according to claim 1, further comprising:
presetting a format of an alarm message; and
populating the alarm message with the account information of the bank account according to the preset format.

6. The method according to claim 1, wherein the account information of the bank account comprises a name, an account number, bank information, and personal information.

7. A bank server of a bank, the bank server comprising:
a storage system;
at least one processor; and
one or more programs stored in the storage system and being executable by the at least one processor, the one or more programs comprising:
a setting module operable to set an alarm password corresponding to a bank account of the bank, and set a restricted amount of money in the bank account;
an identifying module operable to receive information of the bank account and an input password in response to receiving user input, and determine if the input password is the alarm password;
an alarming module operable to acquire account information of the bank account if the input password is the alarm password, generate an alarm message that is populated with the account information, and send the alarm message to a receiving device of one or more emergency dispatchers; and
an account processing module operable to log into the bank account, compare an account balance of the bank account with the restricted amount, determine if the account balance is greater than the restricted amount, and display the restricted amount on an account interface provided by the bank server if the account balance is greater than the restricted amount, or display the account balance on the account interface if the account balance is less than the restricted amount.

8. The bank server according to claim 7, wherein the setting module is further operable to set restricted actions on the bank account, and set a dialog message to display that a restricted action is denied in response to receive an instruction of the restricted action.

9. The bank server according to claim 8, wherein the account processing module is further operable to receive an instruction of a current action on the bank account, determine if the current action is one of the restricted actions, display the dialog message on the account interface to prompt that the current action is denied if the current action is one of the restricted actions, or allow the current action if the current action is not one of the restricted actions.

10. The bank server according to claim 7, wherein the one or more programs further comprise a recording module operable to record all actions applied to the bank account, generate an action log comprising the recorded actions, and store the action log into the storage system.

11. The bank server according to claim 7, wherein the setting module is further operable to preset a format of an alarm message, and the alarming module is further operable to populate the alarm message with the account information of the bank account according to the preset format.

12. The bank server according to claim 7, wherein the account information of the bank account comprises a name, an account number, bank information, and personal information.

13. A storage medium storing a set of instructions, the set of instructions capable of being executed by a processor to perform a bank alarm method for securing bank accounts, the method comprising:
setting an alarm password corresponding to a bank account of a bank, and setting a restricted amount of money in the bank account;
receiving information of the bank account and an input password in response to receiving user input;
determining if the input password is the alarm password;
acquiring account information of the bank account if the input password is the alarm password;
generating an alarm message that is populated with the account information, and sending the alarm message to a receiving device of one or more emergency dispatchers;
logging into the bank account;
comparing an account balance of the bank account with the restricted amount, and determining if the account balance is greater than the restricted amount;
displaying the restricted amount on an account interface provided by a bank server of the bank if the account balance is greater than the restricted amount; or
displaying the account balance on the account interface if the account balance is less than the restricted amount.

14. The storage medium as claimed in claim 13, wherein the method further comprises:
setting restricted actions on the bank account; and
setting a dialog message to display that a restricted action is denied in response to receive an instruction of the restricted action.

15. The storage medium as claimed in claim 14, wherein the method further comprises:
receiving an instruction of a current action on the bank account, and determining if the current action is one of the restricted actions;
displaying the dialog message on the account interface to prompt that the current action is denied if the current action is one of the restricted actions; or allowing the current action if the current action is not one of the restricted actions.

16. The storage medium as claimed in claim 13, wherein the method further comprises:
recording all actions applied to the bank account;
generating an action log comprising the recorded actions; and
storing the action log into a storage system of the bank server.

17. The storage medium as claimed in claim 13, wherein the method further comprises:
presetting a format of an alarm message; and
populating the alarm message with the account information of the bank account according to the preset format.

18. The storage medium as claimed in claim 13, wherein the account information of the bank account comprises a name, an account number, bank information, and personal information.
